(19) United States
(12) Patent Application Publication
(10) Pub. No.: US 2018/0224930 A1
(43) Pub. Date: Aug. 9, 2018

(54) IMMERSIVE VIRTUAL REALITY LOCOMOTION USING HEAD-MOUNTED MOTION SENSORS

(71) Applicant: Board of Regents of the Nevada System of Higher Education, on Behalf of the University of Nevada,, Reno, NV (US)

(72) Inventors: Eelke Folmer, Reno, NV (US); Samuel Tregillus, Sparks, NV (US)

(73) Assignee: Board of Regents of the Nevada System of Higher Education, on Behalf of the University of Nevada,, Reno, NV (US)

(21) Appl. No.: 15/750,137

(22) PCT Filed: Aug. 4, 2016
(86) PCT No.: PCT/US2016/045646

§ 371 Date: Feb. 2, 2018

Related U.S. Application Data
(60) Provisional application No. 62/200,980, filed on Aug. 4, 2015.

(51) Int. Cl. G06F 3/01; G02B 27/01; A63F 13/211; G06F 3/0481; A63F 13/428

(52) U.S. Cl. CPC G06F 3/012; G02B 27/017; A63F 13/211; A63F 2300/105; A63F 13/428; A63B 2220/803; G06F 3/04815

(57) ABSTRACT

Innovations for interactive computer displays (e.g., virtual reality systems) are presented. Motion sensor data is obtained from a motion sensor mounted to a user's head. The motion sensor data is analyzed to determine user movement. A display is updated based on the user movement and output to a display device. Particular embodiments enable a user's natural movement styles to create movement in a virtual reality environment in a highly immersive manner. Further, certain embodiments allow for the user to walk in place (or run in place) and translate that motion into suitable, realistic virtual velocity values for use in a VR environment.

### CROSS REFERENCE TO RELATED APPLICATIONS

This application claims the benefit of U.S. Provisional Patent Application No. 62/200,980 entitled “INTERACTIVE DISPLAY USING HEAD-MOUNTED MOTION SENSOR” filed on Aug. 4, 2015, which is hereby incorporated herein by reference by reference in its entirety.

### BACKGROUND

Wearable interactive virtual reality displays are becoming increasingly ubiquitous due to some major advances that have significantly reduced their cost. However, it remains a challenge to develop immersive, realistic, and natural ways for users to interact and experience virtual movement with such interactive displays.

### SUMMARY

Systems and methods of the present disclosure can provide a number of advantages. For example, using natural movement styles of users can allow for interaction with an interactive display, such as a virtual reality environment, without requiring user input devices (such as buttons or joysticks) that require conscious manipulation by the user. The user of natural movement styles can also decrease the cost of providing the interactive display as well as making the interactive display more natural, intuitive, and immersive to use for the user, than currently available control methods. Similarly, the use of external motion sensing systems, such as cameras, is not required, nor is this feasible in mobile virtual contexts. Allowing a user to interact with the display through natural motions may have additional advantages, such as reducing the incidence of virtual reality simulation sickness, or similar negative physical or mental effects, that can be associated with the usage of interactive virtual reality displays. At least certain implementations of the systems and methods disclosed herein can be carried out in compact systems, such as a smartphone or a virtual reality headset, that can provide advantages in terms of cost, ease of use, and portability.

In one example embodiment, the present disclosure provides a pedometry-based movement method that translates user movement, such as steps, detected via a head-mounted sensor into movement in an interactive display, such as simulated environment, for example, a virtual reality environment. In specific examples, the present disclosure employs a real-time step detection method that simulates moving the user forward within a virtual environment in the direction that they are looking.

In another embodiment, the present disclosure provides a system for implementing the above-described method. In a particular implementation, the system includes a motion sensor, a movement computation module, and a display generation module. In various examples, the system additionally includes a display device and/or additional sensors.

Some example embodiments disclosed herein include a virtual reality system comprising a motion sensor; a display device; a housing configured to house the motion sensor and the display device and further being configured to be worn on or held against a head of a user such that the display device is oriented toward and in a fixed relationship with the eyes of the user; a processor; and a storage device or memory. In these embodiments, the storage device or memory can store processor-executable instructions, which when executed by the processor cause the processor to: receive data from the motion sensor; compute gravity-axis movement data from the data received from the motion sensor, the gravity-axis movement data indicating movement of the motion sensor along the axis of gravity; compute virtual reality velocity values from the gravity-axis movement data; and update a display of a virtual reality space displayed on the display device to show virtual movement within the virtual reality space in accordance with at least the computed virtual reality velocity values.

In some example implementations, the virtual reality velocity values comprise velocity values for movement in an x-y plane perpendicular to the axis of gravity. For example, the movement detected along the axis of gravity is translated into a forward (or backward) velocity value for use in updating the user's position in the virtual reality environment. In certain example implementations, the virtual reality velocity values comprise velocity values for a jumping movement along at least the axis of gravity. In some example implementations, the computing of the virtual reality velocity values is performed using the gravity-axis movement data but not any horizontal plane movement data (e.g., motion detected in the user's x-y plane is ignored). In certain example implementations, the computing the of the virtual reality velocity values comprises: detecting a first step by detecting that a first rate of change in data from the motion sensor satisfies a threshold rate of change used for step detection; detecting a second step by detecting that a second rate of change in data from the motion sensor satisfies the threshold rate of change used for step detection; and computing the virtual reality velocity value based at least in part on a time measured between the first step and the second step. In some example implementations, the computing the virtual reality velocity values comprises: computing the virtual reality velocity responsive to detecting two or more steps, each step being triggered by a rate of change in data from the motion sensor satisfying a threshold rate of change used for step detection; and incrementally reducing the virtual reality velocity in between the two or more steps. Further, the incremental reduction of the virtual reality velocity can produce non-constant virtual reality velocity values in between steps. In certain implementations, the system further comprises one or more gyroscopes, and the processor-executable instructions further cause the processor to: receive data from the one or more gyroscopes; compute directional head-tilt data from the data received from the one or more gyroscopes; and update the display of the virtual reality space displayed on the display device to show virtual movement within the virtual reality space in accordance with at least the computed virtual reality velocity values, the virtual movement being in a direction indicated by the directional head-tilt data. In some implementations, the motion sensor and the display device are located in a unitary housing. For instance, the motion sensor and the display can be located in a smartphone, and the housing can be a smartphone adaptor configured to removably hold the smartphone. In such embodiments, the smartphone and/or the smartphone adaptor can further include one or more gyroscopes. For instance, the smartphone adaptor itself may include one or more additional motion sensors (e.g., accelerometers, gyroscopes, etc.) that can be used alone or in conjunction with motion data detected from motion sensors onboard the smartphone. Further, in certain implementations, the motion sensor can comprise a multi-axis accelerometer and the data received can be x-, y-, z-axis acceleration data. In some implementations, the data received from the motion sensor is generated by the user walking in place or running in place.

Further example embodiments disclosed herein are methods for controlling a virtual reality display. Such examples can comprise, by computing hardware configured to compute virtual reality velocity values used in real-time rendering of a virtual environment via a virtual reality display device: receiving an indication of a first step and an indication of a second step, the indications being based on movements detected by an accelerometer satisfying a step threshold; computing a first step-triggered virtual reality velocity value based on a time difference between the first step and the second step; incrementally reducing the first step-triggered virtual reality velocity value before receiving an indication of a further step; receiving an indication of a third step, the indication of the third step also being based on movements detected by the accelerometer satisfying the step threshold; and computing a second step-triggered virtual reality velocity value based on a time difference between the second step and the third step.

In some example implementations, the incrementally reducing the first step-triggered virtual reality velocity value before receiving the indication of a further step causes a non-constant virtual reality velocity from being applied between the first step and the third step, thereby creating a realistic rendering of human movement that is free of any illusion of “gliding” as occurs when virtual velocities remain constant during movement. In certain example implementations, the movements detected by the accelerometer satisfying the step threshold are movements filtered to be movements along the axis of gravity for the accelerometer. In some example implementations, the incrementally reducing the first step-triggered virtual reality velocity value before receiving an indication of a third step comprises reducing the virtual reality velocity value at multiple rendered frames (e.g., each rendered frame) between a frame rendered according to the second step and a frame rendered according to the third step.

In another disclosed embodiment, a hybrid step detection and virtual movement computation approach can be used. For example, responsive to detecting real positional movement from one or more virtual reality system sensors, a virtual reality locomotion technique translating the real positional movement into virtual movement is applied. Then, responsive to detecting that the real positional movement has stopped but that stepping movements are occurring from the one or more virtual reality system sensors (e.g., as detected by one or more an external camera system, an internal vision based depth sensor, or other motion sensor (accelerometer, gyroscope, GPS, etc.), a virtual reality locomotion technique that translates walking-in-place motion or running-in-place motion into virtual reality motion is applied. For instance, any of the walking-in-place or running-in-place movement detection and virtual velocity translating techniques described herein can be applied upon sensing that positional movement has stopped but that steps are being made by the user of the virtual reality system. In some implementations, an indication that an impediment prevents real positional movement along a current path is displayed to the user of the virtual reality system.

Any of the disclosed embodiments can be implemented as computer-executable instructions stored on a computer-executable media (e.g., a non-transitory storage device or memory storing such computer-executable instructions). Further, any of the disclosed embodiments can be performed by computing hardware, such as a microprocessor, an application specific integrated circuit (ASIC), a field programmable gate array (FPGA), and/or a graphics processing unit (GPU), depending on the implementation.

Still further, the innovations can be implemented as part of a method, as part of a computing system adapted to perform the method, or as part of non-transitory computer-readable media storing computer-executable instructions for causing a computing system to perform the method. The various innovations can be used in combination or separately.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example computing system for an interactive display system (e.g., a virtual reality system) according to embodiments of the disclosed technology.

FIG. 2 is a flowchart of an example method for updating a display based on user movement determined from data from a head-based motion sensor.

FIG. 3 is a diagram illustrating a generalized implementation environment in which some described examples can be implemented.

FIG. 4 shows traces of acceleration magnitudes obtained from user studies where the users were walking (a, b, and c) or running (d, e, and f) with sensors located on a user's head (a, d), hand (b) or arm (e), or in the user's pocket (c, f).

FIG. 5 is an image of a virtual reality environment used in user studies of a method and system according to an embodiment of the disclosed technology.

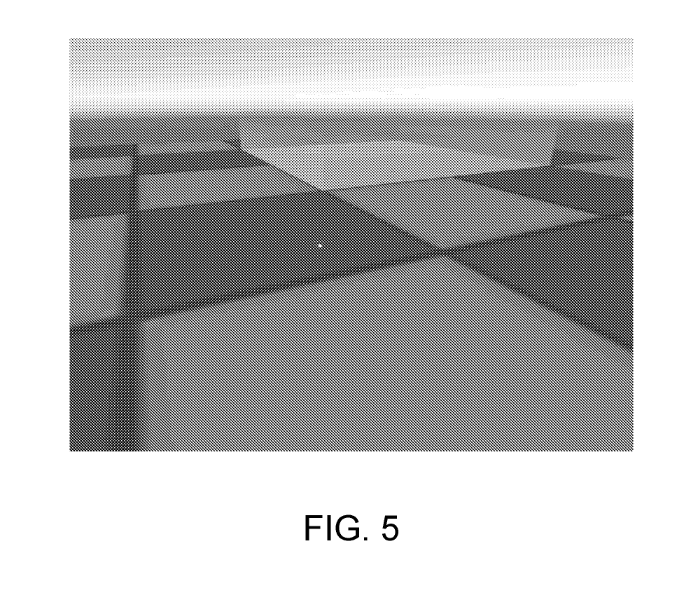

FIG. 6 is a flow chart illustrating an exemplary embodiment of a step detection and virtual velocity conversion procedure in accordance with the disclosed technology.

FIG. 7 is a flow chart illustrating another exemplary embodiment of a step detection and virtual velocity conversion procedure in accordance with the disclosed technology.

FIG. 8 is a diagram of a finite state machine showing various states for a hybrid step detection and virtual velocity conversion procedure in accordance with the disclosed technology.

FIG. 9 is a flow chart illustrating an exemplary embodiment of a step detection and virtual velocity conversion procedure in accordance with the disclosed technology.

FIG. 10 is a flow chart illustrating another exemplary embodiment of a step detection and virtual velocity conversion procedure in accordance with the disclosed technology.

FIG. 11 shows two graphs illustrating accelerometer values and forward virtual velocity values generated in accordance with an embodiment of the disclosed technology.

FIG. 12 is an image showing an example virtual reality adapter for a smartphone.

### DETAILED DESCRIPTION

### I. General Considerations

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” Further, as used herein, the term “and/or” means any one item or combination of items in the phrase.

Virtual reality has reached potential for mainstream adoption due to the introduction of low-cost smartphone adapters, such as Google Cardboard, that can transform any smartphone into a head-mounted virtual reality display. The majority of these applications limit the user to a fixed point in 3D virtual space while allowing them to look around. Since the smartphone is hidden away in the housing, typical smartphone controls like the touchscreen and buttons are not accessible, and buttons or switches on the mount itself have limited input options and do not offer immersive natural forms of interaction. User movement in the 3D virtual reality world is usually either automatic or handled by looking at specific points in the 3D world. For example, a user may start and stop movement by looking at a button rendered somewhere on a generated display, such as in an area that is intended to be fairly innocuous, such as an area of the environment rendered when the user directs their head down, as if they were looking at their feet.

The present disclosure describes example systems and methods for interacting with a virtual environment in more natural and intuitive ways, even with comparatively common, self-contained systems such as smartphones.

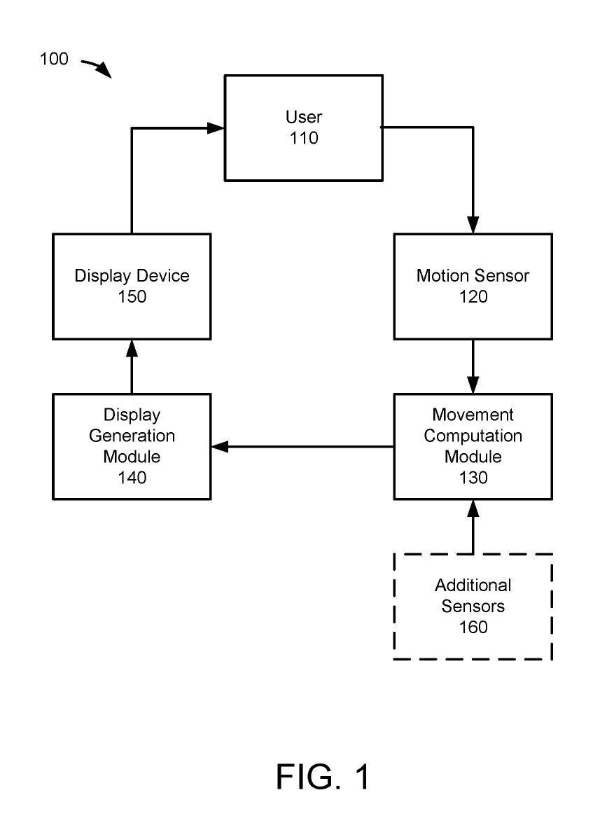

FIG. 1 is a schematic diagram of a system 100 that can be used to implement embodiments of the disclosed technology. In general, the system 100 uses motion data from a sensor located on or proximate to a user's head to alter a display provided to the user. The system 100 includes a motion sensor 120 that is configured to be located on or proximate to the head of a user 110. In various implementations, the sensor may be mounted proximate one or more of the user's eyes, ears, nose, or the top of the user's head. For example, the sensor may be associated with a display located proximate to the user's eyes and nose, or a sensor located in or on the user's ear. In other examples, the sensor is mounted proximate to another location on the user's head.

The motion sensor 120 may be any motion sensor that is capable of detecting user movement. In a specific implementation, the motion sensor 120 is an accelerometer. In some examples, the motion sensor 120 obtains movement information with regard to a single axis, such as an x-axis representing vertical movement of the user 110. In other examples, the motion sensor 120 obtains movement information with regarding to multiple axes, such as axes that represent x, y, and z movement in Cartesian space, which can, for example, correspond to the user 110 moving up or down (z axis), forward or backward (y axis), or side to side (x axis). In other examples, the motion sensor obtains different data, such as non-Cartesian data. One or more additional motion sensors can also be present in the system 100 and provide useful data to detect motion and orientation. For example, the system 100 can include a gyroscope to detect system orientation relative to the gravity vector or one or more magnetometers to detect system orientation relative to magnetic north or some other magnetic field.

The motion sensor 120 is coupled to a movement computation module 130. The movement computation module 130 analyzes data sent, or otherwise obtained, from the motion sensor 120. The movement computation module 130 analyzes data from the motion sensor 120 to determine whether the user 110 has moved and, if so, in what manner. For example, the movement computation module 130 may determine whether the user 110 has taken one or more steps, how quickly the steps are taken (such as whether the user 110 is running or walking), or whether the user 110 is engaged in some other type of motion, such as jumping. The movement computation module 130 can perform a step detection and virtual velocity conversion procedure that uses the detected data from the motion sensor 120 to compute velocity value for use in realizing user movement within the virtual environment. This velocity value is thus sometimes referred to as a virtual velocity value.

The system 100 also includes a display generation module 140. The display generation module 140 generates output that is used to present a display on a display device 150. The display generation module 140 may be, for example, a program or application running on a computing device, such as a personal computer, a laptop, a smartphone, a virtual reality headset, or a wearable computing device, such as a smart watch. In a particular implementation, the display generation module is a computer program that generates (renders) a virtual reality environment.

The display generation module 140 receives information regarding movement of the user 110 from the movement computation module 130 (e.g., a virtual velocity value and, in some instances, a direction in which to apply the virtual velocity value). The display generation module 140 alters the display on the display device 150 in response to user movement. In a particular example, when user movement is detected, the display generation module alters the display to simulate corresponding movement in the displayed environment. For example, the display may display visual information that changes with respect to the user's location in a simulated environment, as well as the user's orientation in the displayed environment. So, as the user 110 moves in the real world, corresponding motion is simulated in the virtual environment, such that objects may be rendered as appearing nearer or further away, more or less detailed rendered for particular objects, and objects being rendered or not rendered depending if they would be in the user's simulated line of sight in the virtual environment.

In some implementations, the motion sensor 120 and movement computation module 130 detect movement that is directly translated for the display generation module 140 into a corresponding movement in the virtual environment. For example, if the user 110 is walking or running, corresponding changes to the perspective shown in the virtual environment are made by the display generation module 140 and rendered on the display device 150. In other implementations, the user's motion is not directly translated or simulated. For example, the movement computation module 130 may generate movement data indicating that the user is walking or running, when in fact the user 110 is stationary. That is, the user 110 may be walking in place (WIP) or running in place (RIP). In some cases, the motion sensor 120 and the movement computation module 130 are unable to distinguish between actual running and walking and running or walking in place. In other cases, the motion sensor 120 and/or movement computation module 130 are able to distinguish between actual motion and “in place” motion. In such cases, the movement computation module 130 and/or display 140 generation module may also choose to distinguish between such motion, with only actual motion giving rise to forward translation in the virtual environment (with “in place” motion being ignored or giving rise to analogous “in place” perspective changes in the virtual environment), or may treat actual motion and “in place” motion as equivalent.

In some implementations, the display generation module 140 uses movement data from the movement computation module 130 to start or stop movement in the display. For example, the detection of a “step” may start movement at a constant velocity until another command or movement is detected to indicate that the simulated movement should stop. In other implementations, the movement computation module 130 and display generation module 140 more accurately translate user movement into perspective changes in the display. For example, a user 110 making multiple “steps” may increase the velocity of the perspective changes in the display. Similarly, a user 110 making a larger number of steps in a time period may be used by the movement computation module 130 and display generation module 140 to increase the rate of perspective changes in the display versus a smaller number of steps in a time period.

In some implementations, the movement simulated by the display generation module 140 ceases when user movement is no longer detected. For example, movement by the user 110 may have a 1:1 correspondence with perspective changes in the display. In other examples, user movement is not exactly corrected with perspective changes. For example, rather than the perspective changes abruptly halting when user movement is no longer detected, the perspective changes may cease after a period of time, gradually slow down, or gradually slow down and then cease.

The movement computation module 130 is optionally in communication with additional sensors 160, or the movement computation module 130 can use data from the motion sensor 120, to detect additional types of movement that can then be converted and used by the display generation module 140 to alter the display. For example, the additional motion sensor 160 can be one or more of a gyroscope, an additional accelerometer, a magnetometer, other movement data from the motion sensor 120, a GPS sensor, an external camera system, or an onboard vision-based depth sensor. The movement computation module 130, in one implementation, uses the data from the additional sensors 160 to determine the relative position of the head of the user 110, such as to determine where the user 110 is looking/a focal area.

The display generation module 140, in some implementations, uses the focal area to adjust the perspective of the generated display. For example, as a user 110 turns their head, the display generation module 140 can cause the display device 150 to display portions of the environment that would be viewable by the user 110 given the current focal point. This focal point information can be combined with the previously-described “step-based” movement information to provide for directional perspective changes in the display, such as simulating movement (for example, walking or running) in a simulated environment. In this way, the user 110 can be presented with a display that allows them to walk, run, move, or otherwise cause perspective changes in different direction, as well as moving “forward” in the display environment.

In further implementations, the motion data processed by the movement computation module 130 can be used for purposes other than causing perspective changes in a simulated environment. In a particular implementation, the movement can be used as an input/selection device. For example, a “jump” or “stomp” motion may be used to interact with the display generation module 140, such as to bring up a menu or select items from a menu.

The display device 150, in particular implementations, is a television, video monitor, computer screen, laptop screen, tablet computer or smartphone screen, or a virtual reality headset. In some examples, the display device 150 is part of a head-mountable virtual reality (“VR”) unit that includes a display and a processor in communication with the display and configured to be mounted on the user's head.

In yet further examples, the VR unit also incorporates one or more of the motion sensor 120, the movement computation module 130, the display generation module 140, and the additional sensors 160. In specific implementations, the display device 150 and the motion sensor 120 are located in a unitary housing. For example, many smartphones are capable of detecting user movement with accelerometer and gyroscope data using sensors built in as standard components of the smartphone.

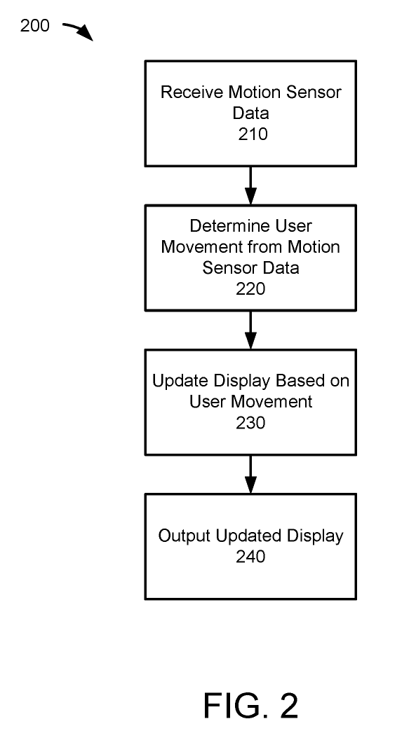

FIG. 2 illustrates an example method 200 according to an embodiment of the present disclosure. At 210, motion sensor data is received from a motion sensor associated with the head of a user. As described above, the motion sensor may be located on or proximate various portions of the user's head. At step 220, user movement is determined from the motion sensor data. For example, the method 200 may apply various algorithms to analyze the motion sensor data to determine what kind of user motion is represented by the data. In a particular implementation, the algorithm determines whether motion sensor data, such as from an accelerometer, exceeds a threshold value or a threshold rate. If the threshold value (or rate) is exceeded, the user is determined to have taken a step, such as a running step or a walking step. The magnitude of the motion sensor data and/or the frequency with which the threshold is detected (potentially along with various directional components of the motion sensor data), may be used to help distinguish whether a particular step is a running step (or a running-in-place step) or a walking step (or a walking-in-place step), or some other kind of user movement, such as a jump. This data can then be converted into a virtual velocity value used to describe user motion in the virtual environment. Example virtual velocity determination techniques are described in detail below.

A display is updated in response to the user movement in step 230 (e.g., by applying the virtual velocity value determined as well as any other relevant movements detected, such as head turns, etc.). As described above, the display may be updated to represent perspective changes resulting from a change in the point of view from which the display is being rendered. That is, objects may be rendered as appearing larger or smaller, or in more or less detail, depending on whether the new viewpoint is nearer or further from the object. Similarly, objects may be rendered or not rendered, depending on whether the object would be within a line of sight from the new viewpoint.

In step 240, the updated display is output to a display device.

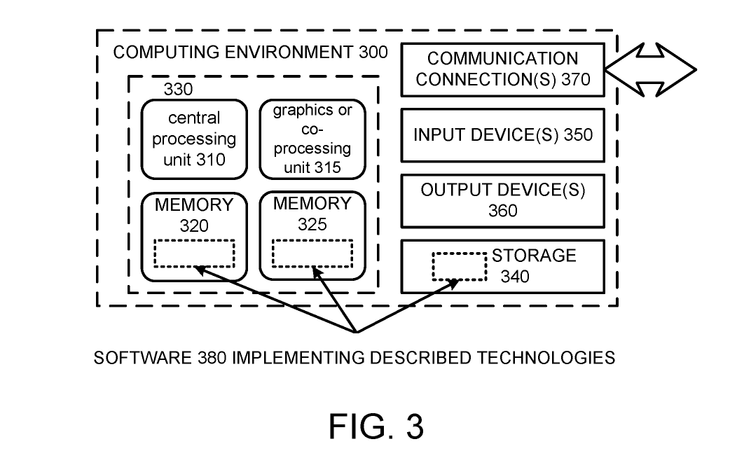

FIG. 3 depicts a generalized example of a suitable computing environment 300 in which the described innovations may be implemented. The computing environment 300 is not intended to suggest any limitation as to scope of use or functionality, as the innovations may be implemented in diverse general-purpose or special-purpose computing systems. For example, the computing environment 300 can be any of a variety of computing devices (e.g., desktop computer, laptop computer, server computer, tablet computer, media player, gaming system, smartphone, smart watch, mobile device, etc.)

With reference to FIG. 3, the computing environment 300 includes one or more processing units 310, 315 and memory 320, 325. In FIG. 3, this basic configuration 330 is included within a dashed line. The processing units 310, 315 execute computer-executable instructions. A processing unit can be a general-purpose central processing unit (CPU), an application-specific integrated circuit (ASIC), a field programmable gate array (FPGA), a graphic processing unit (GPU), or any other type of processor. In a multi-processing system, multiple processing units execute computer-executable instructions to increase processing power.

For example, FIG. 3 shows a central processing unit 310 as well as a graphics processing unit or co-processing unit 315. The tangible memory 320, 325 may be volatile memory (e.g., registers, cache, RAM), non-volatile memory (e.g., ROM, EEPROM, flash memory, etc.), or some combination of the two, accessible by the processing unit(s). The memory 320, 325 stores software 380 implementing one or more innovations described herein, in the form of computer-executable instructions suitable for execution by the processing unit(s). For example, memory 320 and 325 and software 380 can store computer-executable instructions for displaying multi-dimensional visualizations.

A computing system may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The tangible storage 340 may be removable or non-removable, and includes magnetic disks, magnetic tapes or cassettes, CD-ROMs, DVDs, or any other medium which can be used to store information and which can be accessed within the computing environment 300. The storage 340 stores instructions for the software 380 implementing one or more innovations described herein.

The input device(s) 350 may be a touch input device such as a keyboard, mouse, pen, or trackball, a voice input device, a scanning device, or another device that provides input to the computing environment 300. The output device(s) 360 may be a display, printer, speaker, CD-writer, or another device that provides output from the computing environment 300.

The communication connection(s) 370 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field Programmable Gate Arrays (FPGAs), Application Specific Integrated Circuits (ASICs), Graphical Processing Units (GPUs), Application-specific Standard Products (ASSPs), Systems-On-A-Chip (SOCs), Programmable Logic Devices (PLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Step Detection Using Head-Mounted Sensor and Comparison with Sensors Located on Other Body Positions

The accuracy of pedometry can vary depending on where an inertial sensor is located on a user's body. This Section demonstrates that accurate pedometry can be achieved using a head-mounted device. A study with 16 subjects was carried out to compare the accuracy of pedometry for walking and running with an inertial sensor located at the head, pocket and hand/arm. The study did not detect a significant difference in step counting accuracy between sensor locations.

Wearable computing has garnered significant interest, with a number of systems currently available. Of specific interest are smart-glass based head-mounted displays (“HMD”), like Google Glass, or virtual reality displays. Wearables typically support eyes- and hands-free interaction, which allows them to be used in active contexts, such as walking or running.

Pedometry (step counting), is used in various mobility related applications, such as physical activity tracking or infrastructure-free indoor navigation. Pedometry can be achieved with wearable accelerometers (e.g., Fitbit) or using inertial sensors that have become ubiquitous in smartphones and HMDs. Because wearables are often used in active contexts, they are an especially good fit for pedometry-based applications, like physical activity tracking.

In at least some cases, the accuracy of pedometry may vary depending on where an inertial sensor is placed on the human body, with a higher accuracy typically being achieved with sensors closest to the feet, due to damping. Sensors mounted on or in proximity to the head have not been explored, possibly because the head is the furthest from the feet, and this might be expected to provide lower accuracy. This Section demonstrates that pedometry using motion data obtained from a HMD can be achieved with the same accuracy as using a smartphone positioned at other locations. In addition to walking, the performance was investigated for running.

II.A. Study Setup

This Section describes a study demonstrating the accuracy of pedometry using data obtained from a motion sensor associated with a HMD with pedometry using a smartphone placed at other locations on a user's body. This comparison was motivated at least in part by wearable devices often featuring the same inertial sensors as smartphones. HMDs and smartphones are devices that can run applications whereas wearable accelerometers typically only offer limited user interaction. HMDs and smartphones are also typically heavier than wearable accelerometers.

II.A.1. Instrumentation

Google Glass was used as the HMD. Google Glass is a wearable voice-controlled Android device that resembles a pair of glasses. Google Glass has various sensors: a camera, a microphone, 3-axis accelerometer, 3-axis gyroscope, 3-axis magnetometer, ambient light, and a proximity sensor. Google Glass weighs 50 grams and runs on the Android OS. For a smartphone, a Samsung 19300 Galaxy S III was used, because this phone features the same 3-axis accelerometer (Invensense MPU6050) as Google Glass, minimizing differences in results due to differences in hardware. This smartphone weights 133 grams and measures 137×71×9 mm and runs on Android OS. A single Android 4.0.3 application was developed to collect acceleration data. The same application ran on both the smartphone and Google Glass to mitigate differences in performance due to differences in code or OS. When the application was running, data collection started as soon as the smartphone screen or the Google Glass touchpad was tapped. The application created a log file for each trial with each line holding a sample and each sample containing a timestamp and the accelerations for the x, y, and z axes. If the screen or touchpad was tapped again, data collection stopped. Data from Google Glass was down-sampled from 200 Hz to 100 Hz to match the sampling frequency of the smartphone. In order to synchronize the traces prior to each trial, each application sent a time request to a Network Time Protocol server at the beginning of each trial. The response from the server was then used as the offset from the device's native clock and was added to every timestamp recorded from the sensor. Experimental results demonstrated that such time requests have an accuracy of a few tens of milliseconds, which was deemed acceptable.

II.A.2. Participants

Sixteen students (8 females and 8 males, average age 29.69, SD=7.14, average height 172 cm, SD=9.85 cm) were recruited to participate in the study. One subject was left handed. None of the subjects self-reported any non-correctable impairments in perception or limitations in mobility.

II.A.3. Procedure

Subjects were equipped with a Google Glass device. For walking, subjects held one smartphone in their dominant hand, and placed a second smartphone in their right front pant pocket. Prior to equipping the subjects, an observer activated each application to start data collection, first starting the smartphones and then Google Glass. Subjects were instructed not to touch the smartphone screens or Google Glass touchpad during the trial. Subjects were then asked to walk 40 steps in a straight line. A straight line was used as it resembles the type of interaction for which accurate pedometry on a HMD offers the most useful applications (e.g., indoor navigation/health tracking).

Experiments were conducted in an indoor environment: a long hallway that was approximately eight feet wide with floors made out of linoleum tiles. This environment was free of obstacles and people. Once each subject completed 40 steps, that subject tapped the touchpad on the Google Glass device to end the trial, and then the observer stopped the data collection on the smartphones.

To gather data from running motion, each subject wore Google Glass, attached one smartphone to the bicep of their dominant arm using an armband, and placed a second smartphone in their right front pant pocket. Subjects ran 30 steps and followed the same procedure as for walking. 30 steps running was approximately the same distance as 40 steps walking. Data collection on the Google Glass was ended first followed by the smartphones.

Subjects were asked to perform each walking and running trial three times. Subjects were split into two groups with the first group first walking and then running and the other group the other way around. Each trial was video recorded. Subjects were instructed to verbally count out their steps. An observer also counted the number of steps each subject took in each trial.

II.A.4. Results

After the trials, the raw acceleration data from all three devices were gathered and analyzed. Each application execution represents a trace. Each entry in a trace includes accelerations in the three major axes with their corresponding timestamps. To analyze this data, the acceleration magnitude was calculated for each entry. The data was then smoothed using a centered moving average. The traces were matched with each other and synchronized based on their timestamps. As the Google Glass app was activated last and ended first, the start and end timestamps on the Google Glass trace were used to trim the smartphone traces to avoid picking up unintentional accelerations associated with touching and attaching the smartphones. A video review verified the step count for each trial.

II.D. Step counting algorithm

Windowed peak detection (“WPD”) was used as the step-detection algorithm, WPD first smooths the acceleration magnitude using a centered moving average window of size (MovAvg). WPD detects steps using a sliding window of a fixed size (PeakDet) to detect a single peak. The algorithm finds the maximum value in the window and then shifts the window. If, after the shift, a new max is found, the previous peak is replaced if it is still present in the window. WPD is computationally inexpensive, which reduces battery consumption on mobile devices.

TABLE 1
Step counting error (%) for individual subjects and positions

| | Walk | | | Run | | |
|---|---|---|---|---|---|---|
| Subject | hand | head | pocket | arm | head | pocket |
| 1 | 2.5 | 3.33 | 1.67 | 2.22 | 1.11 | 3.33 |
| 2 | 3.33 | 3.33 | 2.5 | 0 | 3.41 | 2.3 |
| 3 | 0.81 | 5.73 | 0 | 0 | 0 | 0 |
| 4 | 5 | 3.33 | 3.33 | 1.08 | 0 | 1.08 |
| 5 | 0.83 | 1.67 | 4.17 | 0 | 0 | 3.23 |
| 6 | 0 | 0 | 1.67 | 1.11 | 0 | 0 |
| 7 | 3.33 | 0 | 0 | 1.08 | 1.08 | 1.08 |
| 8 | 0.83 | 0 | 1.67 | 0 | 0 | 1.08 |
| 9 | 0 | 1.67 | 1.67 | 3.41 | 0 | 1.15 |
| 10 | 7.5 | 2.5 | 5 | 2.19 | 0 | 0 |
| 11 | 0 | 0.83 | 0.83 | 0 | 1.08 | 1.08 |
| 12 | 1.69 | 0.85 | 1.69 | 2.19 | 0 | 0 |
| 13 | 0 | 2.5 | 2.5 | 0 | 0 | 2.22 |
| 14 | 1.67 | 0 | 5 | 1.08 | 3.19 | 3.18 |
| 15 | 2.5 | 1.67 | 2.5 | 1.08 | 0 | 1.11 |
| 16 | 3.33 | 3.33 | 2.5 | 2.12 | 1.08 | 2.12 |
| Average | 2.08 | 1.92 | 2.29 | 1.1 | 0.68 | 1.4 |
| St. Dev | 2.02 | 1.59 | 1.46 | 1.04 | 1.09 | 1.13 |

II.E. Error Extraction

The error for the step detection algorithm was defined as the absolute difference of the number of steps calculated by the algorithm from the ground truth:

$${e}_{ij} ( k ) = \frac{\vert {steps}_{ij} ( k ) - {ij}_{} ( k ) \vert}{{steps}_{ij} ( k )} \qquad ( 1 )$$

where i represents a specific position, k is the trial, stepsᵢⱼ (k) is the approximation of steps subject j took according to WPD, stepsᵢⱼ is the ground truth observation for the number of steps subject j took, and eᵢⱼ (k) is the error for user j for a specific position i, for a specific trial k. Each subject performed three trials for walking and running. The error for each trial is defined as:

$${e}_{ij} = \frac{{\sum }_{k = 1}^{n} {e}_{ij} ( k )}{n} \qquad ( 2 )$$

where eᵢⱼ represents the average error for subject j at position i, and n represents the number of trials (n=3).

II.F. Parameter Optimization

Because running and walking can be accurately classified, different parameter values were used for walking and running to optimize the performance of the WPD algorithm. A visual inspection of traces annotated with steps detected revealed that step counting errors are either caused by: (1) the selection of the window size (PeakDet); or (2) noise from the user (MovAvg). Too much smoothing eliminates valid peaks and not enough smoothing causes errors due to noise. To determine the optimum values for these parameters, a search was performed of all reasonable values to minimize the overall average step counting error in a combined dataset for all users and positions but split by type of activity. Table 2 shows the selected values.

TABLE 2
Optimal WPD parameter values for walking and running

| Experiment | Parameter Values |
|---|---|
| Walking | MovAvg = 280 ms, PeakDet = 430 ms |
| Running | MovAvg = 115 ms, PeakDet = 230 ms |

II.G. Accuracy Comparison

Table 1 lists the average step counting error over the three trials for running and walking for the three positions explored. For the walking trials, the head position achieved the best results with an average error of 1.92% (SD=1.59%). Similarly, for the running trials, the head position yielded the best results with an average error of 0.68% (SD=1.09%). A one-way ANOVA found no statistically significant difference in average step counting error rate between head, hand and pocket for walking (F_{8,39}=0.968, p=0.475) or running (F_{2,45}=0.269, p=0.765). For walking and running, no significant difference between over, under, and exact counting of steps was found. A one-way ANOVA found a significant difference in error rate between walking and running for the head and pocket positions (F_{1,61}=16.863, p=0.000). The hand and arm error rates were excluded from this analysis.

II.H. Discussion

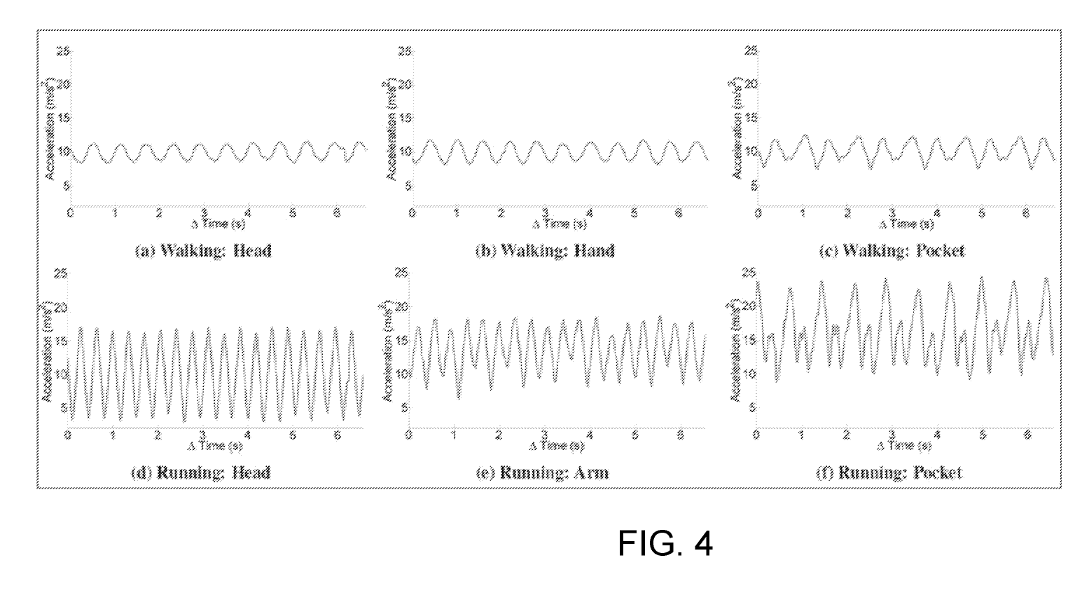

Analysis of the data found no significant difference in step counting accuracy between a HMD and smartphones worn in the user's pant pocket or held in the hand/arm. This result is contrary to expectations, as it was anticipated that step counting would be worse for the head location, as accelerations would be more damped, since the head is more distant from the feet than the other locations explored. FIG. 4 shows six traces of the observed acceleration for the three different locations for a running and walking trial. Though the amplitudes of the peaks for the pocket location are slightly higher than for the head and hand locations, this difference does not significantly affect the performance of the WPD algorithm.

The step counting error for running was significantly lower than for walking. When running, the heel strikes the ground with a higher velocity than when walking, so the magnitude of the observed accelerations is larger. The amplitude and frequency of the peaks are significantly higher for running than for walking. Some notable differences between traces for different locations of the accelerometer can be observed. The head (FIGS. 4(a) and 4(d)) and hand (FIG. 4(b)) traces resemble smooth sinusoids. The arm (FIG. 4(e)) and pocket (FIGS. 4(c) and 4(f)) traces look different and resemble unbalanced sinusoids with peaks that alternate in amplitude (a high peak is followed by a low peak). Because the pocket and arm locations are right above the leg, they pick up accelerations from a heel strike from one leg more strongly than the other. The closer an accelerometer is placed to the sagittal plane (the vertical plane dividing the body into a left and right half), the more balanced the sinusoid of the acceleration signal will be. More accurate pedometry algorithms could potentially be developed that exploit the asymmetrical inertial signals of the pocket and arm locations.

For running, the arm picks up additional accelerations from swinging the arms back and forth, which causes the amplitudes of these peaks to be slightly higher than for the head location (FIGS. 4(e) and 4(d)). Although no significant difference between locations was found, the step counting error for running for the hip and bicep were nearly twice that of the head. Smart watches are considered less obtrusive than smart glasses, but the results of this Example indicate that pedometry using a head-mounted sensor, such as smart glasses, may be more accurate than pedometry based on smart watch-based sensors, given that runners swing their arms while running and a higher noise can be expected for the wrist position than the bicep position.

The Samsung smartphone weighs nearly three times as much as Google Glass. This difference in mass could affect its ability to accurately pick up accelerations (with heavier devices sensing accelerations more accurately). The larger distance from the feet makes it harder for Google Glass to pick up accelerations, and noise is more often falsely classified as a step. However, Google Glass is reasonably firmly attached to the user's head, as it rests on the nose bone where the skin is very thin, which minimizes damping. A human head also weighs approximately 8% of the total body weight, which overall leads to relatively smooth sinusoids with little noise that allows for accurate step detection. In addition to sensors located on the front of the face, sensors may be located on other parts of the head. For example, “hearables”, i.e., standalone smart in-ear headphones (e.g., Bragi The Dash) that offer fitness tracking functionality may used to obtain data that can be analyzed for pedometry information.

### III. Using Pedometry Data from a Head-Mounted Sensor to Traverse a Virtual Environment

### III.A. Brief Overview of Disclosed Technology

Low-cost smartphone adapters can bring virtual reality to the masses, but input is typically limited to using head tracking, which makes it difficult to perform complex tasks like navigation. Walking-in-place (WIP) offers a natural and immersive form of virtual locomotion that can reduce simulation sickness. WIP, however, is difficult to implement in mobile contexts, as it typically relies on an external camera. In this Section, example embodiments are disclosed that use real-time pedometry to detect steps while a user walks or runs in place and convert those steps into velocity values that can be used to implement virtual locomotion. In certain example embodiments, the disclosed technology (sometimes referred to herein as VR-STEP) requires no additional instrumentation outside of a smartphone's inertial sensors (e.g., accelerometers and gyroscope) or outside of a VR headset's inertial sensors (e.g., accelerometers and gyroscope). A user study with 18 users compared an implementation of the disclosed technology with a commonly used auto-walk navigation method and found no significant difference in performance or reliability, though the disclosed technology was found to be more immersive and intuitive.

### III.B. Introduction and Background to Disclosed Technology

Virtual reality (VR) has reached potential for mainstream adoption due to the introduction of low-cost smartphone adapters (housings) that can transform any smartphone into a head-mounted VR display. Examples of such adapters/housings include Google Cardboard, FreeFly VR, Homido VR, and Samsung Gear VR. One challenge with such head-mounted displays is that their input options are limited. For instance, because the smartphone is inside the adapter, touchscreen input is not possible. Further, a separate controller cannot be used with certain adapters (e.g., Google Cardboard adapters) because the user is required to hold the adapter with both hands. Due to these constraints, input typically relies on head-tracking using the smartphone's inertial sensors. Several VR apps feature an auto-walk button that is rendered at the user's feet. Users toggle the auto-walk by looking down at the button briefly, which then starts moving the user in the direction of their gaze. Besides being limited to a fixed locomotion speed, this method requires users to interrupt their focus on the virtual environment to look down at the button, which may be detrimental to immersion and undesirable in gaming contexts that may rely on quickly and freely moving within the virtual game space.

Walking-in-place (WIP) allows users to perform hands-free virtual locomotion using step-like movements while remaining stationary. WIP resembles walking and offers a natural, immersive form of input. When compared to using a controller, WIP allows for better spatial orientation while approximating the performance of real walking. Simulation sickness is a major concern to the mass adoption of VR and is caused by—among other factors—a sensory mismatch between visual and vestibular stimuli. Because WIP generates proprioceptive feedback, users are less likely to experience simulation sickness than when using a conventional controller. As used herein, “walking in place” and “running in place” encompass user motion where the user's feet may not leave the ground but the user's legs flex such that the torso of the user's body moves up and down along the gravity axis (e.g., bouncing in place at a first rate to indicate walking steps and/or bouncing in place at a second faster rate to indicate running steps).

The disclosed technology addresses the need for a low-cost virtual locomotion technique by presenting example embodiments of a WIP technique that require no instrumentation beyond the sensors already present in smartphones (or, in some cases, already present in the VR headset). Embodiments of the disclosed technology are immersive, have low latency, and are easy to learn. Also provided is a quantitative and qualitative comparison of an embodiment of the disclosed technology with another hands-free navigation technique that is found in several VR apps. The results highlight the desirability of smooth, natural movement and low starting/stopping latency in VR locomotion.

Exploring natural, immersive types of input for virtual locomotion is an active field of research. Using a joystick for navigation is a simple and common approach. Gaze-based navigation with joystick control of locomotion speed was found to be superior to navigation using a joystick alone. However, real walking, where the user actually moves in real space, is the most natural and effective method for virtual locomotion. Real walking can be implemented using an optical tracking system, but this approach does not scale well since the tracked space and the virtual space need to be the same size. Additionally, such optical tracking systems are prohibitively expensive for average consumers. Omnidirectional treadmills can be used to circumvent physical space limitations, but these are expensive and bulky, which restricts their use in mobile contexts.

Walking-in-place (WIP), as is used in embodiments of the disclosed technology, has many advantages over other methods for virtual locomotion. WIP can be used to control locomotion speed just as effectively as using a joystick, but WIP has also been found to be much more immersive. Maintaining spatial knowledge of the virtual world is difficult in VR environments, but WIP was found to allow for better spatial orientation than when using a joystick. WIP has also been found to be almost as efficient as real walking but is not subject to space constraints and is therefore more cost effective to implement. A challenge with implementing WIP is starting and stopping latency (how quickly a step is detected and translated into virtual motion, or how long it takes the virtual avatar to stop after the user stops taking any steps). High stopping and starting latency makes precise navigation challenging. Latency can be a result of the step detection algorithm implementation, noise reduction, or damping based on which part of the body is being tracked. Embodiments of the disclosed technology are capable of detecting steps quickly (e.g., after one step) and exhibit desirably low latency.

### III.C. Example Implementations

Inertial measurement units (IMU) have become ubiquitous in smartphones and typically consist of a 3-axis accelerometer and 3-axis gyroscope. Rather than using an external sensor, embodiments of the disclosed technology use a smartphone's (or a HMD's) accelerometer for step detection. Since the smartphone sits in the head-mounted adapter/housing, latency is a major concern for effective virtual locomotion. One challenge to address with this approach is that a smartphone worn on the head may dampen the acceleration signal (due to the larger distance from the feet), causing problems for accurate step detection. However, as discussed above, the accuracy with which pedometry can be achieved on a head mounted display has been evaluated and no significant difference in accuracy was observed for sensors worn on or near the head when compared with a smartphone worn on in the pocket or held in the hand.

A variety of step detection algorithms can be used to implement embodiments of the disclosed technology. For instance, any of the algorithms described in Agata Brajdic and Robert Harle, “Walk Detection and Step Counting on Unconstrained Smartphones,” in Proceedings of the 2013 ACM International Joint Conference on Pervasive and Ubiquitous Computing, 225-234 (2013) can be adapted for use with the disclosed VR locomotion technique. In one example implementation (the VR-STEP implementation), the real-time algorithm described in Zhao, N., “Full-featured pedometer design realized with 3-axis digital accelerometer,” Analog Dialogue 44-06 (2010), is used for step detection. This algorithm has little computational overhead and ensures the smartphone can maintain a high frame rate, which is desirable for VR simulations. In one particular implementation, the algorithm averages every 5 samples to smooth the acceleration signal, which minimizes noise while still yielding a near real-time response of between 100-200 ms. The number of samples to be averaged, however, can vary from implementation to implementation (e.g., 2-50 samples) and will generally depend on the desired latency experienced and the sampling rate for the sensor (e.g., the accelerometer and/or gyroscope).

In one example implementation, a step is detected if the averaged accelerometer values pass a dynamic threshold level with a large enough slope (e.g., a negative slope or positive slope, depending on the configuration). In other words, a step is detected if the rate of change of the averaged accelerometer values passes a threshold level, where the threshold level represents a threshold rate of change (slope). This rate of change can correspond to the sensor quickly stopping, as occurs when the user's foot hits the ground at the end of a step, or making some other rapid change in motion. In particular implementations, the threshold is dynamic. For example, the threshold can change every n samples (e.g., 50 samples) from the accelerometer to account for different step intensities. The slope acts as a sensitivity setting, which can be tuned to make sure that small steps that the user uses to turn left and right are not translated into forward movement.

Once steps are detected, and in accordance with certain embodiments of the disclosed technology, they are translated into virtual locomotion, in the direction of the user's gaze (e.g., by converting the data into virtual velocity values). Embodiments of the disclosed technology allow users to feel like they have precise control over their velocity, to be able to move reasonable distances quickly, but also be able to make small changes in position if needed. Because users walk in place, there is no way to detect the length of their stride to determine how far users might want to move. A discrete approach where every detected step is translated into moving a fixed distance forward leads to jarring and unnatural movement. A high stopping latency can make users experience a frustrating sensation of gliding. Embodiments of the disclosed technology can overcome these issues.

In one example implementation, the accelerometer and/or gyroscope values are queried to determine acceleration along the gravity axis. These acceleration values are input into a step-detection method (e.g., a step-detection procedure described in Zhao, N., “Full-featured pedometer design realized with 3-axis digital accelerometer,” Analog Dialogue 44-06 (2010)). A sensitivity value, S, can be used to modify how sensitive the algorithm is. The sensitivity value S, for instance, can be the threshold slope for triggering step detection. When a step is detected, an event is fired, which a step handler listens for. The step handler can implement a virtual velocity conversion procedure and may be part of, for example, the movement computation module of a virtual reality system. The step handler is configured to measure the time between steps, (tₛₜₑₚ) to determine the virtual velocity (v). A large tₛₜₑₚ indicates that the user is walking slowly, so v can be set to a relatively low value. A small tₛₜₑₚ value indicates faster steps, so v can be set to a higher value. The conversion of tₛₜₑₚ to v values can be performed according to a fixed formula (e.g., an inverse linear relationship or any suitable polynomial (any suitable k-th degree polynomial)). In other embodiments, the conversion can be performed according to a table (e.g., a look-up table providing v values for any input tₛₜₑₚ value or range of tₛₜₑₚ values), whose values can be populated experimentally or heuristically based on the virtual-reality application developer's preferences. As explained above, the virtual velocity values (v) can then be used by the rendering engine of the VR application to display the virtual motion.

In particular implementations, the tₛₜₑₚ values and/or velocity values can be at least partially bounded (e.g., bounded to have a minimum, a maximum, or both). For instance, in one particular implementation, bounds can be established on tₛₜₑₚ∈[Iₘᵢₙ; Iₘₐₓ], and a maximum and minimum velocity, [Vₘᵢₙ; Vₘₐₓ]. In this implementation, if tₛₜₑₚ>Iₘₐₓ, it means that a step has not been detected in some time (the user has been standing still before they took this step), so v is set to Vₘᵢₙ. tₛₜₑₚ<Iₘᵢₙ is typically not possible (as Iₘᵢₙ is usually set low enough to encompass the fastest physically possible running motion), and it may be filtered out by the step detector as noise, but if tₛₜₑₚ<Iₘᵢₙ, velocity is set to Vₘₐₓ. If tₛₜₑₚ∈[Iₘᵢₙ; Iₘₐₓ], v is linearly interpolated between [Vₘᵢₙ; Vₘₐₓ] according to:

$$v = \frac{{t}_{step} - {I}_{min}}{{I}_{max} - {I}_{min}} * ( {V}_{max} - {V}_{min} ) + {V}_{min} \qquad ( 3 )$$

By modifying their WIP speed, users can have precise control over their virtual speed.

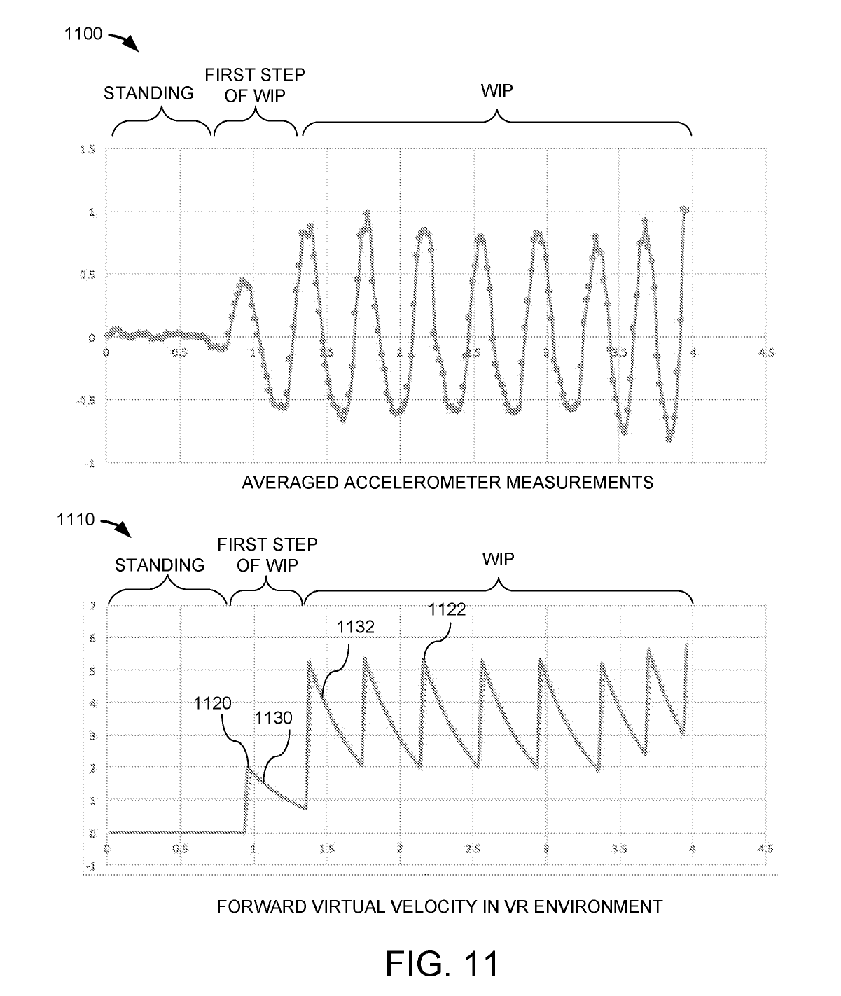

To further improve the immersive experience, particular embodiments adjust the velocity of the avatar between steps by applying friction. For instance, the velocity value (v) can be incrementally reduced between detected steps. For instance, the velocity value (v) can be reduced linearly by subtracting a friction constant (f) every frame, millisecond, second, or other interval. In other embodiments, the velocity value (v) can be reduced nonlinearly by a nonconstant friction value (f), which may be computed according to any suitable formula or polynomial (any suitable k-th degree polynomial), or in accordance with some table of values. For instance, as illustrated in FIG. 11, the velocity values can decrease in an asymptotic fashion. The use of a friction value slows down movement of the user in virtual space between steps, giving a natural feeling of walking. It also reduces stopping latency, since the user begins slowing down immediately after taking their last step. If the user continues walking-in-place or running-in-place, the velocity value is re-computed, giving the feeling of constant but realistic motion.

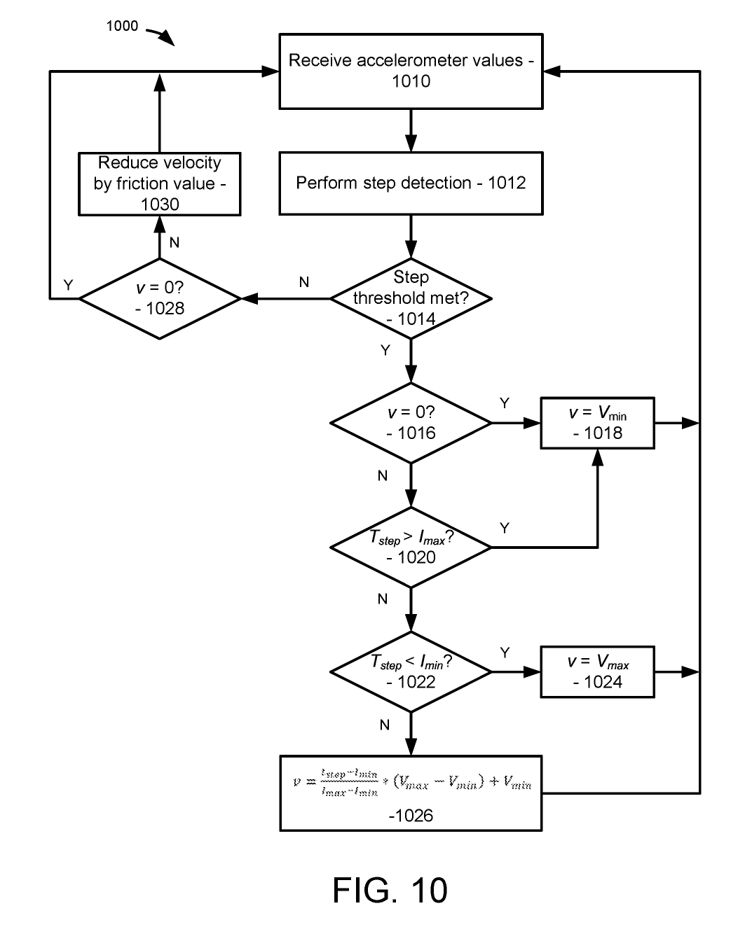

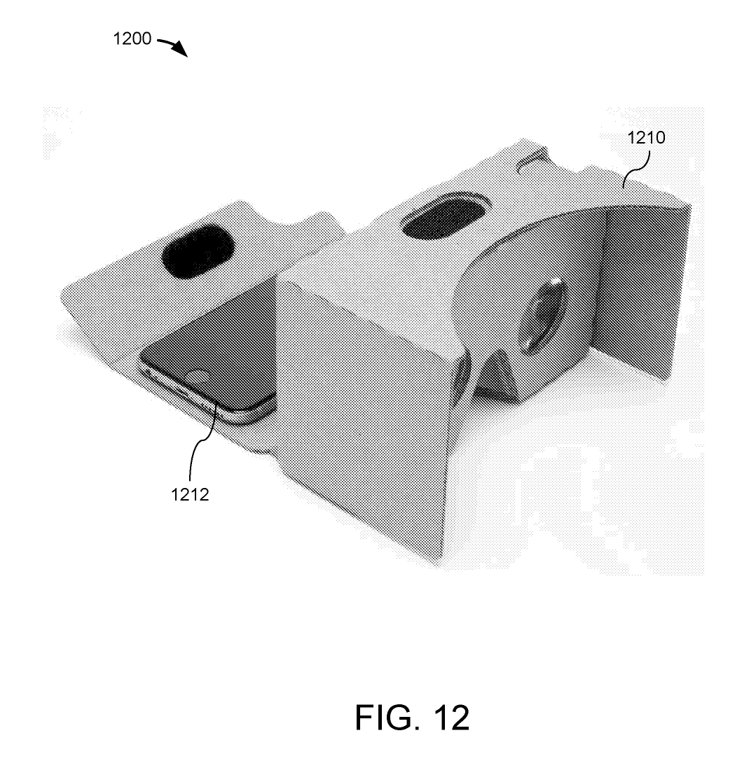

FIG. 10 is a flow chart 1000 illustrating an exemplary embodiment of a step detection and virtual velocity conversion procedure in accordance with the disclosed technology as described in the previous paragraphs. The illustrated embodiment can be implemented, for example, in a virtual reality system comprising a motion sensor, a display device, and a housing configured to house the motion sensor and the display device. The housing can be further configured to be worn on or held against a head of a user such that the display device is oriented toward and in a fixed relationship with the eyes of the user (e.g., a virtual reality smartphone adapter, such as Google Cardboard). The housing may further include lenses. An example housing 1210 for housing a smartphone 1212 and adapting it into a VR system is shown in image 1200 of FIG. 12, though it should be understood that the VR system may also be implemented using a VR-dedicated head-mounted display. The virtual reality system further comprises a processor, a storage device, and/or memory. When a smartphone is used, these hardware components (the processor, storage device, and memory) are in the unitary body of the smartphone itself. The storage device or memory can store processor-executable instructions, which when executed by the processor cause the processor to perform the illustrated method. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 1010, data from one or more motion sensors are received. In the illustrated embodiment, data from an accelerometer array (x-, y-, z-accelerometer values) are received.

At 1012, step detection is performed. For example, any of the step detection processes as described above can be used to analyze data from the one or more motion sensors and, at 1014, to determine whether a step has occurred (e.g., by satisfying a step threshold, such as a rate-of-change threshold as described above).

If the step threshold has been reached, then, in the illustrated embodiment, an evaluation is made at 1016 to determine whether the VR system (and thus the user) is stationary and whether the step is potentially the first detected step after a period of the user being stationary. In particular, an evaluation is made to determine whether the current virtual velocity value (v) is set to “0”. If so, then the new virtual velocity value is set to a minimum velocity (Vₘᵢₙ) at 1018. The procedure then repeats at 1010. If the virtual velocity value is not 0 (e.g., >0), indicating that a previous step has recently occurred, then the process proceeds to evaluate how the time between detected steps (Tₛₜₑₚ) can be used to determine a virtual velocity value in acts 1020, 1022, 1026.

In other embodiments, however, the evaluation at 1016 is omitted; for instance, the initial value of Tₛₜₑₚ can be set so that it is always greater than Iₘₐₓ, thus allowing an initial velocity to be set, even in the case where a first, single step is detected.

At 1020, for example, an evaluation is made to determine whether Tₛₜₑₚ is greater than Iₘₐₓ (or, in some cases, greater than or equal than Iₘₐₓ). If so, this indicates that the user is stepping relatively slowly. Thus, the virtual velocity value (v) is set to its minimum value at 1018. The procedure then repeats at 1010.

At 1022, and continuing with the example, an evaluation is made to determine whether Tₛₜₑₚ is less than Iₘᵢₙ (or, in some cases, less than or equal than Iₘᵢₙ). If so, this indicates that the user is stepping relatively quickly. Thus, the virtual velocity value (v) is set to its maximum value at 1024. The procedure then repeats at 1010.

At 1026, and in this example, because the Tₛₜₑₚ value has been determined to be between Iₘᵢₙ and Iₘₐₓ as a result of the evaluations at 1020 and 1022, an intermediate virtual velocity value is computed. For instance, the value is computed according to the illustrated formula, but can be computed according to other formulas as well.

Returning to 1014, if a step threshold is not detected, then the procedure progresses to determine whether the user is already stationary or intends to slow down to a stationary state. In the illustrated embodiment, the process continues to 1028, at which point a determination is made as to whether the virtual velocity value is “0”. If so, this indicates that the user has not made a step recently, and thus has come to a stop, as reflected by the virtual velocity value being “0”. Accordingly, the procedure repeats at 1010. If a step has not been taken and if the virtual velocity value is greater than “0” (e.g., in the case of the user having a positive velocity and either intending to stop or being in between steps), the procedure branches to 1030, where the virtual velocity value (v) is reduced. As noted above, the virtual velocity value (v) can be reduced linearly (e.g., by a constant value), nonlinearly, or according to some other formula/procedure for reducing velocity after a step is detected.

FIG. 11 shows two graphs 1100, 1102 that illustrate how virtual velocity values (here, forward velocity values) can be computed using embodiments of the disclosed technology (e.g., any of the techniques described above, including for instance the technique illustrated in FIG. 10). Graph 1100 illustrates accelerometer values on the y axis (averaged over a small sample size (e.g., 5 samples)) over time on the x axis (here, seconds). The values were generated by a user standing and then starting to walk in place. The resulting changes in the values can be categorized as the phases “standing”, “first step of walking in place (WIP)”, and “walking in place (WIP)” highlighted in graph 1100.

Graph 1102 illustrates forward virtual velocity values generated from the detected accelerometer values of graph 1100 using an embodiment of the disclosed technology. In particular, graph 1102 shows the virtual velocity values (v) to be applied in the VR environment along the y axis over time on the x axis. The illustrated values fall into the same phases of “standing”, “first step of walking in place (WIP)”, and “walking in place (WIP)”. As shown, a small velocity value (here “2”) is applied after a single step and then, after each step, a new velocity value is computed based on the time between steps (tₛₜₑₚ) as explained above, resulting in the virtual velocity spikes shown in graph 1110 (two examples of which are shown at 1120, 1122). Also illustrated in graph 1110 is how the friction value causes the virtual velocity to decay between steps (e.g., as shown at representative regions 1130, 1132). In this example, the friction value is nonlinear and, in this particular case, is asymptotic.

With respect to how friction is applied, there is generally a tradeoff between being able to allow for “precise” single steps to be made as well as interpreting multiple steps to gradually increase the velocity of the user (otherwise motions become jittery). The friction value helps prevent against the sensation of gliding, which occurs when no friction, or not enough friction, is applied. Too much friction can lead to a non-realistic experience as well. Consequently, the manner and degree of how the friction value is applied will vary from implementation to implementation and can depend on the VR context in which it is applied.

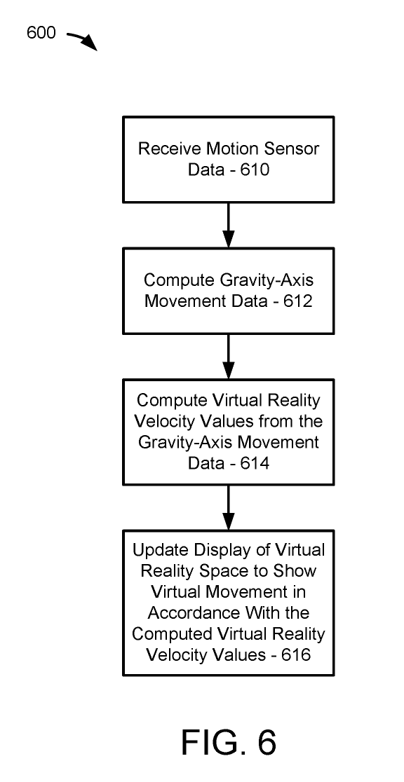

FIG. 6 is a flow chart 600 illustrating another exemplary embodiment of a step detection and virtual velocity conversion procedure. The illustrated embodiment can be implemented, for example, in a virtual reality system comprising a motion sensor, a display device, and a housing configured to house the motion sensor and the display device. The housing can be further configured to be worn on or held against a head of a user such that the display device is oriented toward and in a fixed relationship with the eyes of the user (e.g., a virtual reality smartphone adapter, such as Google Cardboard). The housing may further include lenses. An example housing 1210 for housing a smartphone 1212 and adapting it into a VR system is shown in image 1200 of FIG. 12, though it should be understood that the VR system may also be implemented using a VR-dedicated head-mounted display. The virtual reality system further comprises a processor, a storage device, and/or memory. When a smartphone is used, these hardware components (the processor, storage device, and memory) are in the unitary body of the smartphone itself. The storage device or memory can store processor-executable instructions, which when executed by the processor cause the processor to perform the illustrated method. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 610, data is received from a motion sensor (e.g., acceleration data from one or more accelerometers).

At 612, gravity-axis movement data is computed from the data received from the motion sensor. In the illustrated embodiment, the gravity-axis movement data indicates movement of the motion sensor along the axis of gravity. For example, the x, y, and z acceleration data from the accelerometer can be filtered or further processed to identify the movement data along the gravity axis. In such cases, orientation data from the gyroscope can be used to detect the orientation of the system so that the correct acceleration data (or combination thereof) is identified as being along or substantially along the gravity axis. For instance, the gyroscope information can be used to select which axis of the multi-axis accelerometer data is indicative of up and down movement, and thus can be used as the relevant gravity-axis data.

At 614, virtual reality velocity values are computed from the gravity-axis movement data. For example, any of the embodiments described above can be used. In some example implementations, the computing the virtual reality velocity values is performed using the gravity-axis movement data but not any movement data from the user's x-y plane (the horizontal plane of the user). In such implementations, the gravity-axis-movement data can be converted into a virtual reality velocity value in a different axis—such as in a direction in the x-y plane (the horizontal plane). For instance, the running in place (which produced up-and-down movement data) can be translated into values for indicating forward (or backward) virtual motion. In other example implementations, x-y plane movement data from one or more motion sensors is used as a component in determining the virtual reality velocity value.

In certain example implementations, one example of which is more fully explained above, the computing the virtual reality velocity values comprises: detecting a first step by detecting that a first rate of change in data from the motion sensor satisfies a threshold rate of change used for step detection; detecting a second step by detecting that a second rate of change in data from the motion sensor satisfies the threshold rate of change used for step detection; and computing the virtual reality velocity value based at least in part on a time measured between the first step and the second step. In some example implementations, and as described above, the computing the virtual reality velocity values comprises: computing the virtual reality velocity responsive to detecting two or more steps, each step being triggered by a rate of change in data from the motion sensor satisfying a threshold rate of change used for step detection; and incrementally reducing the virtual reality velocity in between the two or more steps (e.g., by applying a friction value to the velocity value). Further, the incrementally reducing can produce non-constant virtual reality velocity values in between steps, thereby creating a more immersive experience for the user. In certain example implementations, a jump is detected (e.g., because the movement data along the gravity exceeds a second threshold indicative of a substantially larger change in gravity-axis movement than the threshold used for step detection) and the virtual reality velocity values comprise velocity values for a jumping movement along at least the axis of gravity (e.g., in the z direction in the virtual environment).

At 616, a display of a virtual reality space displayed on the display device is updated to show virtual movement within the virtual reality space in accordance with at least the computed virtual reality velocity values.

In some implementations, the motion sensor and the display device are located in a unitary housing. For instance, the motion sensor and the display can be located in a smartphone, and the housing can be a smartphone adaptor configured to removably hold the smartphone. Further, in certain implementations, the motion sensor can comprise a multi-axis accelerometer. In some implementations, the data received from the motion sensor is generated by the user walking or running in place. In certain implementations, the housing comprises a face mount for the motion sensor, the face mount configured to hold the sensor proximate to a location on the user's head.

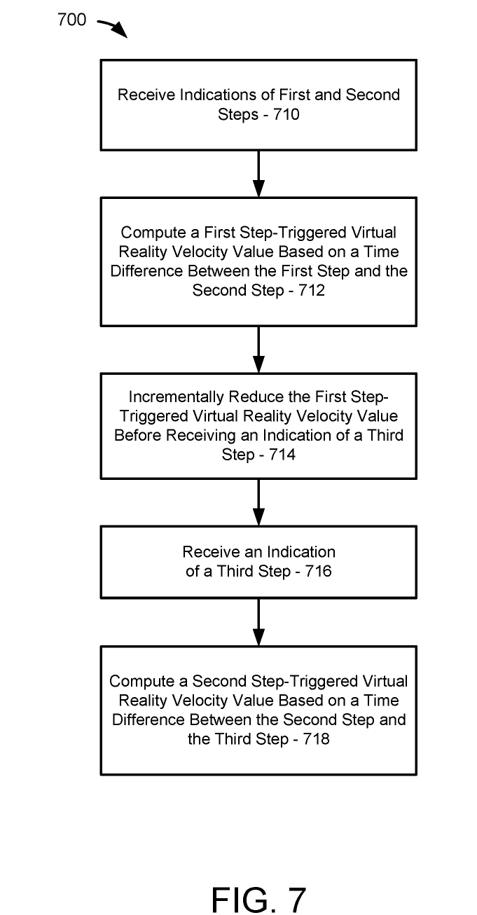

FIG. 7 is a flow chart 700 illustrating another exemplary embodiment of a step detection and virtual velocity conversion procedure. The illustrated embodiment can be implemented, for example, in a virtual reality system as described above. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 710, an indication of a first step and an indication of a second step are received, the indications being based on movements detected by an accelerometer satisfying a step threshold. For example, any of the step-detection approaches described or referenced above can be used.

At 712, a first step-triggered virtual reality velocity value is computed based on a time difference between the first step and the second step.

At 714, the first step-triggered virtual reality velocity value is incrementally reduced before receiving an indication of a third step.

At 716, an indication of a third step is received, the indication of the third step also being based on movements detected by the accelerometer satisfying the step threshold.

At 718, a second step-triggered virtual reality velocity value is computed based on a time difference between the second step and the third step.

In some example implementations, the incrementally reducing the first step-triggered virtual reality velocity value before receiving the indication of the third step causes a non-constant virtual reality velocity to be applied between the first step and the third step. In certain example implementations, the movements detected by the accelerometer satisfying the step threshold are movements filtered to be movements along the axis of gravity or substantially along the axis of gravity for the accelerometer. For instance, gyroscope information can be used to select which axis of the multi-axis accelerometer data is indicative of up and down movement, and thus can be used as the relevant gravity-axis data. In some example implementations, the incrementally reducing the first step-triggered virtual reality velocity value before receiving an indication of a third step comprises reducing the virtual reality velocity value at multiple rendered frames (e.g., each rendered frame) between a frame rendered according to the second step and a frame rendered according to the third step.

### III.D. Evaluation

A number of studies have already compared WIP with joystick based virtual locomotion. But comparisons to other WIP methods that involve extensive instrumentation are not useful for the disclosed technology, as users of mobile VR would not typically have access to such instrumentation. Because embodiments of the disclosed technology are hands free and require no instrumentation, it is more meaningful to compare its performance with another hands free navigation method, “look down to move” (LDTM), which is used in several VR apps, such as the popular Oculus “Tuscany” demo. Users toggle a button at their feet by briefly looking down at it, then back up. When activated the user will move with a fixed horizontal velocity in the direction of their gaze. Similar to other WIP evaluations, an example implementation of the disclosed technology (termed VR-STEP) was compared to LDTM by having users perform a number of navigation tasks.

III.D.1. Instrumentation

For the smartphone mount, a Zeiss VR One was used. The VR One features Zeiss precision lenses with a 100 degree field of view. The VR One features a strap and weighs 590 grams. An Android Nexus 5 smartphone was used for the smartphone. The Nexus 5 has a Qualcomm Snapdragon 800 CPU (2.3 GHz quad-core) and an Adreno 330 GPU which can render 3D simulations with a high frame rate. The Nexus 5 features a InvenSense MPU-6515 six-axis (gyro+accelerometer) with a 50 Hz sample rate. The user study was implemented using the Google Cardboard for Unity SDK and the Unity 5 engine. Because LDTM uses a fixed velocity (VLDTM), a precise quantitative comparison with VR-STEP is challenging, as VRSTEP allows variable locomotion speeds. Even if one were to limit Vₘₐₓ to be the same as VLDTM, the average speed for VRSTEP would be smaller than LDTM unless the participant consistently runs at the highest speed. To allow for a fairer comparison, VR-STEP was modified such that when tₛₜₑₚ<Iₘₐₓ, v was set to VLDTM. If no step has been taken for Iₘₐₓ seconds, v was immediately set to 0. This means that velocity is the same for both methods at all times when moving, but it does make stopping latency for VR-STEP equal to Iₘₐₓ, which causes a minor gliding issue, where after not taking any steps, the user continues to move forward for Imax seconds. For the user study, Imax was to 0.7 s, and VLDTM to 6 m/s.

III.D.2. Participants

Eighteen participants were recruited (9 female, average age 28.83, SD=7.93) to participate in the user study. None of the subjects self-reported any non-correctable impairments in perception or limitations in mobility. Individuals who had previously experienced simulator sickness were excluded from participation as they were at a high risk of not completing the study. User studies were approved by an IRB. On average, users had 4.97 years experience (SD=8.05) navigating 3D environments and 11 subjects had prior experience using a VR headset, such as the Oculus Rift.

III.D.3. Procedure

A criticism of existing WIP studies is that they have mostly included navigation tasks that use a straight trajectory, which is not realistic for many VR applications. The user study performed for the disclosed technology had participants perform two different navigation tasks: an unobstructed navigation task with a straight trajectory, and an obstructed one requiring them to circumnavigate an obstacle. The navigation task was designed to be similar to the one described by Doug Bowman et al., “Travel in immersive virtual environments: An evaluation of viewpoint motion control techniques,” in IEEE Virtual Reality Annual International Symposium, 45-52 (1997).

The virtual environment comprised a flat plane featuring a checkerboard pattern. Participants were asked to find a target zone (a blue transparent column), navigate to it, and remain inside the area for 2 seconds before the next target zone becomes visible. This column changes color when participants enter it, and auditory feedback indicates success. The locations of the target zone were initially determined at random, with each new location a minimum distance of 10 meters away from the prior location. Obstructed navigation tasks feature a rectangular box (size: 1×3 meters) halfway to the target zone. To decouple the visual search task from the navigation task, time and distance traveled were measured as soon as participants started moving. Each participant tested both navigation methods, but which method used first was randomly assigned (half of the participants used VR-STEP first, then LDTM). Participants performed 20 navigation tasks for each navigation method with 10 tasks containing an obstacle. The specific locations of the target zones and the obstacle ordering was the same for all users and both methods. Before the data collection, participants were fitted with the VR One headset and it was ensured that the HMD was firmly attached to their head using the straps. Some participants with eyeglasses took them off but others kept them on. A built-in tutorial explained how each navigation method worked and let participants practice three navigation tasks. After the trials, basic demographic and qualitative feedback was collected using a questionnaire. The entire session, including training and questionnaires, took about 10 minutes.

TABLE 3

| Method-trajectory | Time (s) | SD | Distance (m) | SD |
|---|---|---|---|---|
| LDTM-straight | 59.12 | 25.0 | 225.31 | 127.1 |
| VR-STEP-straight | 61.88 | 8.7 | 198.18 | 13.3 |
| LDTM-curved | 65.31 | 19.2 | 243.25 | 65.4 |
| VR-STEP-curved | 77.45 | 23.3 | 224.87 | 32.3 |

Table 3 lists the results for all users. For the analysis, a two-way repeated measures ANOVA was used where efficiency of each navigation method using time and distance traveled were measured. In particular, Table 3 shows the total time and distance traveled averaged per user.

There was no statistically significant two-way interaction between navigation type and trajectory for navigation time (F1; 17=1:680, p=:212), or distance (F1; 17=:107, p=:784). Pairwise comparisons using a Bonferroni correction found a statistical significant difference between navigation methods for time for a curved trajectory (p=:012) but not for distance or straight trajectories.

After the trial, participants were also asked to rank each navigation method based on a number of criteria which included: efficiency, reliability, learnability, immersion and overall preference. If participants had no preference, they could also select both as a 3rd option. The summarized results are shown in Table 4, where each column shows the number of respondents who chose the corresponding method as their first choice in five categories.

TABLE 4

| | Efficiency | Reliability | Learnability | Immersion | Preference |
|---|---|---|---|---|---|
| VR-Step | 6 | 6 | 12 | 13 | 8 |
| LDTM | 11 | 11 | 1 | 2 | 7 |
| Both | 1 | 1 | 5 | 3 | 3 |

A Chi square test found the rankings for learnability (p=:0023) and immersion (p=:0045) to be statistically significantly different. Non-directed interviews with open-ended questions were used to collect general experiences and identify areas for improvement. For LDTM, ten participants stated that having to look down to activate the button was awkward or strenuous for their neck. Six participants suggested using a larger button or placing the button at eye level. For VR-STEP, eight participants said they found it difficult to stop precisely in the target zone due to gliding. Two participants wanted control over their velocity as they felt their avatar was moving too fast. Three participants wanted better step detection.

### III.E. Discussion

Overall, the study demonstrates the advantages of the disclosed technology as a low-cost virtual locomotion technique for mobile VR. Participants found the VR-STEP implementation more immersive and easy to learn than LDTM. Though LDTM was perceived to be more reliable and efficient, quantitative results only showed LDTM to be faster for curved trajectories. An analysis of paths revealed that some participants overshot the target zone, requiring them to turn around. Overshooting would occur with LDTM as well, but not as frequently as with VR-STEP. If users failed to stop, the switchback they took back to the target zone significantly increased both time and distance, leading to much larger standard deviation values for these metrics.

Ironically, the main user complaints about VR-STEP, high stopping latency (gliding) and no control over speed, are issues that are absent when variable locomotion speed is used, as described above (e.g., where velocity values are incrementally reduced between steps). Because the study was performed with an aim to being able to compare quantitative values, such as navigation speed, between the two methods, the changes that were made to equate velocities ended up hurting user perception of efficiency and reliability. However, these results do highlight how stopping latency impacts user perception. Overshooting is very frustrating to the user, and enabling them to stop intuitively where they would like to is very important. LDTM can have large stopping latency, as users must stop looking at the world to look down at a button. Some participants found a way around this by looking forward and down while navigating, but if your goal is to create an immersive world, this is obviously not what you want your users to be doing. The trade-off made to allow for a fair comparison did clearly demonstrate participant's qualitative preferences for VR-STEP. For VR-STEP, the step detection algorithm described in Zhao, N., “Full-featured pedometer design realized with 3-axis digital accelerometer,” Analog Dialogue 44-06 (2010) was used because of its low computational overhead and consequent high frame rate. Some participants initially expressed that the step detection was not sensitive enough, but when they were instructed to “jog in place” so their head bounced, they were able to use VR-STEP quite efficiently. If a user is already moving, it may be challenging—based on visual feedback alone—to know whether the system has detected a step. When audio feedback was added (e.g., the sound of a footstep), users were able to better anticipate how the system works and modify their stepping input accordingly.

The step-based system of the present disclosure, while useful in a number of VR applications, may be particularly useful in applications where a user would want to be able to move freely and stop to examine the environment around them. The step-based method offers additional advantages. For example, it can be more portable and lower cost than other VR interaction systems. Since the entire system can be contained in the smartphone and the mount (housing), at least in the example embodiments disclosed herein, the method can be used anywhere, with no dependencies on other devices. Since the method can use walking-in-place (WIP) or running-in-place (RIP) for input, the method does not have a high space requirement.

### III.F. Further Embodiments

Embodiments of the disclosed technology can be adapted to have additional features. This section introduced several variants of the disclosed technology, all of which are considered to be within the scope of the disclosed technology.

For example, an intrinsic characteristic of bipedalism is that humans tilt their body and head in the direction that they want to move, e.g., alignment of the body with the gravitational vertical. To take advantage of this existing natural feature, certain example embodiments employ the use of a head tilt to let users use their head as a joystick to specify a direction to navigate to. This feature can be triggered, for instance, using gyroscope readings from the on-board gyroscopes of a smartphone to determine when the head is oriented in a certain direction and below the horizontal plane by some threshold degree (e.g., 2°, 5°, 10°, 15°, or n°, where n is any real number). With the direction of desired movement so-triggered, the velocity of movement in that direction can then be computed using any of the techniques described above. Still further, certain variations of this technique can be realized. For instance, there could be a default direction (forward) that is only overcome by a significant head tilt in another direction (e.g., 10° or greater, 15° or greater, 20° or greater, or n° or greater for any desired value of n). Or, in some implementations, the directions of movement signaled by head tilts are constrained to a subset of directions. For instance, a head tilt may be used only to signal backward movement, or to single backward, left, right, or forward movement, or some other subset that is less than a full range of 360° directional movements.

Still further, the direction currently being selected for movement may be indicated to the user through a visual indicator that is displayed to the user through the VR display (e.g., in the manner of a heads-up display). Such an indicator may be any visual indicator that provides feedback to the user about the direction in which they have selected to move (e.g., a virtual joystick or analog stick, a virtual directional pad, an arrow, a word, or other such graphical user interface mechanism).

For instance, any of the step-based virtual reality systems described herein can comprise one or more gyroscopes, and the step detection and virtual velocity conversion procedure performed by the system can further comprise receiving data from the one or more gyroscopes; computing directional head-tilt data from the data received from the one or more gyroscopes; and updating the display of the virtual reality space displayed on the display device to show virtual movement within the virtual reality space in accordance with at least the computed virtual reality velocity values, the virtual movement being in a direction indicated by the directional head-tilt data.

In another embodiment, a head tilt (as described above) alone is used to cause movement. In such embodiments, the degree of head tilt can be mapped to a velocity so that the degree of head tilt is translated to the velocity of movement in the virtual environment. Or, in other embodiments, a single velocity can be used that is used once a sufficient head tilt is detected. Or, in still other embodiments, a small subset of velocities (e.g., slow, moderate, fast, or other such binned sets of velocities)) can be used so that the velocities can be quickly learned and predicted without having to experience and master a large number of velocities.

In yet another embodiments, the WIP input is combined as part of a hybrid virtual locomotion technique that allows for actual walking. Many VR experiences limited interaction to the size of the tracking space. Alternatively, when a user runs out of tracking space it needs to switch to an artificial virtual locomotion technique such as joystick input, teleportation etc. This transition from real physical walking to an artificial virtual locomotion technique is considered to break immersion and is perceived as unnatural since many of the artificial locomotion techniques such as teleportation are not feasible in real life. The assumption of such a hybrid virtual locomotion technique is that the transition between walking and walking in place is more natural than to existing artificial locomotion techniques, which overall will lead to more immersive VR experiences. In some examples, such techniques can be implemented using VR systems that allow for depth sensing of the surrounding environment, and thus can detect walls and other objects in a real environment that might prevent actual passage of the user.

For instance, one example implementation uses the Google Tango platform. Google Tango is a tablet that features an integrated depth sensor that can enable positional tracking when used for VR. A benefit of using Google Tango is that this solution is fully portable and unlike other systems, does not rely on installing external sensors for tracking. In one example implementation, differences in observed x, y, z positions of the tablet worn by the user are directly translated into virtual displacement using the Tango SDK. At the same time, a window peak step detection algorithm can be run on the vertical y position data. Steps detected are translated into virtual motion using the technique described above. A problem here is that positional motion could also be detected as a step leading to duplicate/erroneous virtual displacement.

To circumvent this problem, and in accordance with one example embodiment, every frame is checked to determine whether displacement in the x, z plane has exceeded threshold distance d, and if so, a Boolean value is set indicating that positional movement is happening.

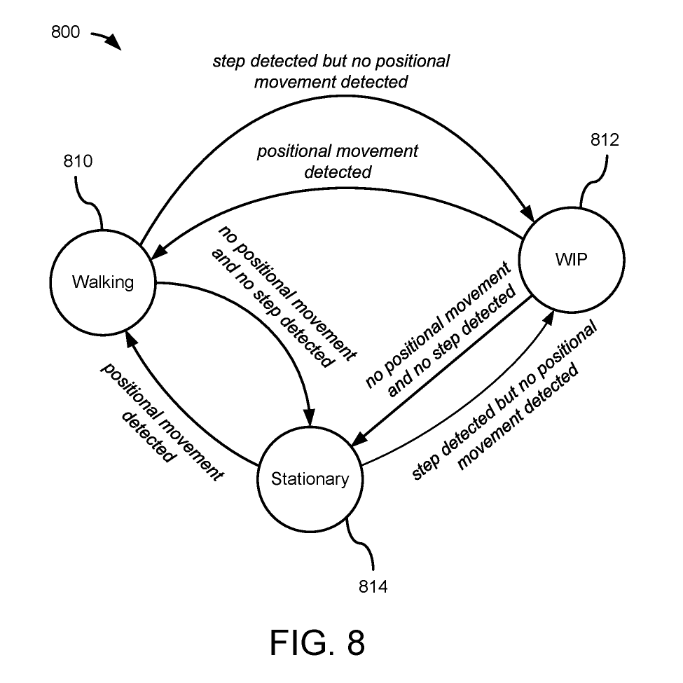

This Boolean will reset to false after a certain timeout when no positional motion is detected. When a WIP step is detected, this Boolean value can be checked to see if the user was engaged in positional tracking. If not, then the step can be registered using the virtual locomotion technique described above leading to forward motion in the direction of the user's current gaze. FIG. 8 is a diagram 800 shows these states in terms of a finite state machine. In FIG. 8, the “walking” state 810, “WIP” state 812, and “stationary” state 814 illustrate respective motion states and, for the “walking” and “WIP” states, respective step detection and virtual reality velocity translation procedures. For instance, in the “walking” state 810, the system can implement a virtual reality locomotion technique translating the real positional movement into virtual movement (e.g., positional motion detected from external sensors, a GPS unit, or positional movement detected from a one or more of an accelerometer, gyroscopes, or magnetometer). Further, in the “WIP” state 812, the system can implement a virtual reality locomotion technique that translates walking-in-place motion or running-in-place motion into virtual reality motion. For instance, such a state can translate gravity-axis information into forward (or backward) virtual reality velocities as described above. As noted, the direction of the velocity can be influenced by the direction of a head tilt or head gaze. Further, the motion detected may be part of actual positional movement.

Further, in particular example implementations, when the user gets close to a physical boundary, a visual indicator can be displayed to the user (e.g., a grid is visualized) to indicate to the user there is a possibility of a collision with a physical boundary. When the grid is visible, users can transition from walking to walking-in-place (WIP). When a boundary is visible, users may also be prompted to take a step back and then transition to WIP.

In some embodiments, various forms of step feedback are provided to the user. For instance, audio feedback can be provided (e.g., sounds of a step) or haptic feedback can be provided. Haptic feedback may be desired in certain contexts (e.g., gaming) where audio feedback may be obfuscated.

Still further, besides detecting steps for walking, other feet-related actions, such as jumps or stomps, may be detected using acceleration. For instance, jumps can be implemented into the technique described above by using a jump threshold for vertical acceleration.

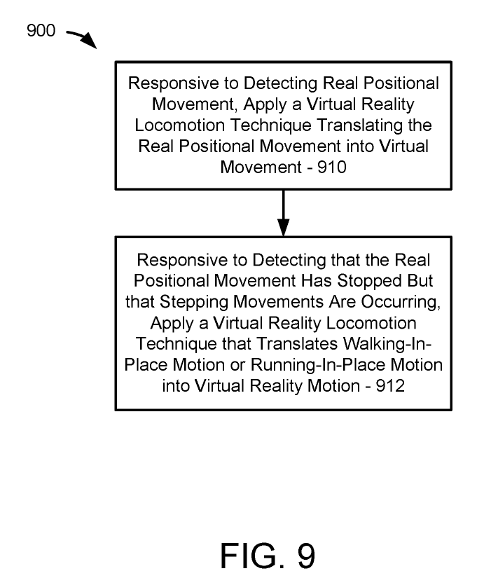

FIG. 9 a flow chart 900 illustrating an exemplary embodiment of a hybrid step detection and virtual velocity conversion procedure. The illustrated embodiment can be implemented, for example, in a virtual reality system as described above. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 910, responsive to detecting real positional movement from one or more virtual reality system sensors, a virtual reality locomotion technique translating the real positional movement into virtual movement is applied.

At 912, responsive to detecting that the real positional movement has stopped but that stepping movements are occurring from the one or more virtual reality system sensors, a virtual reality locomotion technique that translates walking-in-place motion or running-in-place motion into virtual reality motion is applied. For instance, any of the movement detection and virtual velocity translating techniques described herein can be applied upon sensing that positional movement has stopped but that steps are being made by the user of the virtual reality system.

In some examples, an indication of the impediment that prevents real movement along the current path is displayed to a user of the virtual reality sensor array.

### V. Concluding Remarks

The particular application in which the disclosed technology is employed can vary widely—from gaming to exercise applications. In the exercise space, jogging-in-place has already been found to get users into moderate-to-vigorous levels of exercise. In addition, bringing the immersion of VR to exergames could engage players for longer, which may stimulate larger health benefits. This may address some of the current criticisms of exergames that they do not provide sufficient health benefits.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

1. A virtual reality system, comprising:
a motion sensor;
a display device;
a housing configured to house the motion sensor and the display device and further configured to be worn on or held against a head of a user such that the display device is oriented toward and in a fixed relationship with the eyes of the user;
a processor and a storage or memory device, the storage or memory device storing processor-executable instructions, which when executed by the processor cause the processor to:
receive data from the motion sensor;
compute gravity-axis movement data from the data received from the motion sensor, the gravity-axis movement data indicating movement of the motion sensor along the axis of gravity;
compute virtual reality velocity values from the gravity-axis movement data; and
update a display of a virtual reality space displayed on the display device to show virtual movement within the virtual reality space in accordance with at least the computed virtual reality velocity values.

2. The virtual reality system of claim 1, wherein the virtual reality velocity values comprise velocity values for movement in an x-y plane perpendicular to the axis of gravity.

3. The virtual reality system of claim 1, wherein the virtual reality velocity values comprise velocity values for a jumping movement along at least the axis of gravity.

4. The virtual reality system of claim 1, wherein the computing the virtual reality velocity values is performed using the gravity-axis movement data but not any horizontal plane movement data.

5. The virtual reality system of claim 1, wherein the computing the virtual reality velocity values comprises:
detecting a first step by detecting that a first rate of change in data from the motion sensor satisfies a threshold rate of change used for step detection;
detecting a second step by detecting that a second rate of change in data from the motion sensor satisfies the threshold rate of change used for step detection; and
computing the virtual reality velocity value based at least in part on a time measured between the first step and the second step.

6. The virtual reality system of claim 1, wherein the computing the virtual reality velocity values comprises:
computing the virtual reality velocity responsive to detecting two or more steps, each step being triggered by a rate of change in data from the motion sensor satisfying a threshold rate of change used for step detection; and
incrementally reducing the virtual reality velocity in between the two or more steps.

7. The virtual reality system of claim 6, wherein the incrementally reducing produces non-constant virtual reality velocity values in between steps.

8. The virtual reality system of claim 1, further comprising:
one or more gyroscopes; and
wherein the processor-executable instructions, when executed by the processor, further cause the processor to:
receive data from the one or more gyroscopes;
compute directional head-tilt data from the data received from the one or more gyroscopes; and
update the display of the virtual reality space displayed on the display device to show virtual movement within the virtual reality space in accordance with at least the computed virtual reality velocity values,
the virtual movement being in a direction indicated by the directional head-tilt data.

9. The virtual reality system of claim 1, wherein the motion sensor and the display device are located in a unitary housing.

10. The virtual reality system of claim 1, wherein the motion sensor and the display are located in a smartphone, and wherein the housing is a smartphone adaptor configured to removably hold the smartphone.

11. The virtual reality system of claim 1, wherein the motion sensor comprises a multi-axis accelerometer.

12. The virtual reality system of claim 1, wherein the data received from the motion sensor is generated by the user walking or running in place.

13. The virtual reality system of claim 1, wherein the housing comprises a face mount for the motion sensor, the face mount configured to hold the sensor proximate a location on the user's head.

14. A method for controlling a virtual reality display, comprising:
by computing hardware configured to compute virtual reality velocity values used in real-time rendering of a virtual environment via a virtual reality display device:
receiving an indication of a first step and an indication of a second step, the indications being based on movements detected by an accelerometer satisfying a step threshold;
computing a first step-triggered virtual reality velocity value based on a time difference between the first step and the second step;
incrementally reducing the first step-triggered virtual reality velocity value before receiving an indication of a third step;
receiving an indication of a third step, the indication of the third step also being based on movements detected by the accelerometer satisfying the step threshold; and
computing a second step-triggered virtual reality velocity value based on a time difference between the second step and the third step.

15. The method of claim 14, wherein the incrementally reducing the first step-triggered virtual reality velocity value before receiving the indication of the third step causes a non-constant virtual reality velocity from being applied between the first step and the third step.

16. The method of claim 14, wherein the movements detected by the accelerometer satisfying the step threshold are movements filtered to be movements along the axis of gravity for the accelerometer.

17. The method of claim 14, wherein the incrementally reducing the first step-triggered virtual reality velocity value before receiving an indication of a third step comprises reducing the virtual reality velocity value at each rendered frame between a frame rendered according to the second step and a frame rendered according to the third step.

18. The method of claim 14, wherein the computing hardware is one of a hardware processor, an application specific integrated circuit (ASIC), a field programmable gate array (FPGA), or a graphics processing unit (GPU).

19. One or more computer-readable storage media storing computer-executable instructions, which when executed by a computer causes the computer to perform a method, the method comprising:
responsive to detecting real positional movement from one or more virtual reality system sensors, applying a virtual reality locomotion technique translating the real positional movement into virtual movement; and
responsive to detecting that the real positional movement has stopped but that stepping movements are occurring from the one or more virtual reality system sensors, applying a virtual reality locomotion technique that translates walking-in-place motion or running-in-place motion into virtual reality motion.

20. The one or more computer-readable storage media storing computer-executable instructions of claim 19, wherein the method further comprises displaying to a user of the virtual reality system an indication that an impediment prevents real positional movement along a current path.
